(19) United States
(12) Patent Application Publication
(10) Pub. No.: US 2024/0197073 A1
(43) Pub. Date: Jun. 20, 2024

(54) WALL-MOUNTED BRACKET

(71) Applicants: ESSENCE TECHNOLOGY HOLDINGS (HK) LIMITED, HONG KONG (CN); NEXIGHT INC, BEAVERTON, OR (US)

(72) Inventor: DONGWEI YANG, HONG KONG (CN)

(21) Appl. No.: 18/174,643

(22) Filed: Feb. 26, 2023

(30) Foreign Application Priority Data
Dec. 16, 2022 (CN) 202223408657.0

(51) Int. Cl. A47B 96/02; F16M 13/02

(52) U.S. Cl. CPC A47B 96/027; F16M 13/02

(57) ABSTRACT

The present disclosure provides a wall-mounted bracket. The wall-mounted bracket includes a host holder and an accessory holder. The accessory holder is connected to a side of the host holder, and that side is away from the bracket mounting wall. The accessory holder includes a first accessory holding portion and a second accessory holding portion arranged side by side. The wall-mounted bracket provided in the present disclosure may be hung on the bracket mounting wall, optimizing idle vertical space to store the gaming device, thereby reducing the occupation of the user's readily available space. Further, the width of the first holding portion and the second holding portion when they are arranged side by side matches the width of the host holder, thus maximizing the efficiency of the space occupied by the gaming device.

### CROSS-REFERENCE TO RELATED APPLICATIONS

The present disclosure claims priority of Chinese Patent Application No. 202223408657.0 and application name of “Wall-Mounted Bracket”, filed on Dec. 16, 2022, the contents of which are hereby incorporated by reference.

### TECHNICAL FIELD

The present disclosure relates to the field of storage appliances for gaming devices, and in particular, to a wall-mounted bracket.

### BACKGROUND

Gaming devices, such as PlayStation 4, PlayStation 5, and consoles from other series, comprise a host device and multiple accessories, which need to be stored when the gaming device is not in use. When the host and the accessories are piled up disorderly, they may occupy a large space. Therefore, it has become an urgent technical problem to provide a storage appliance for storing the gaming device within a small space.

### SUMMARY

In an aspect, the present disclosure provides a wall-mounted bracket. The wall-mounted bracket includes a host holder and an accessory holder. The accessory holder is connected to a side of the host holder, and that side is away from the bracket mounting wall, and the accessory holder is configured to hold multiple accessories of the gaming device. The accessory holder includes a first accessory holding portion and a second accessory holding portion, and the first accessory holding portion and the second accessory holding portion are arranged side by side.

In another aspect, the present disclosure provides a wall-mounted bracket. The wall-mounted bracket includes a host holder and an accessory holder. The accessory holder is connected to a side of the host holder, and that side is away from the bracket mounting wall. The host holder includes at least one through-hole.

In a further aspect, the present disclosure provides a wall-mounted bracket. The wall-mounted bracket includes a host holder and an accessory holder. The accessory holder is connected to a side of the host holder, and that side is away from the bracket mounting wall.

### BRIEF DESCRIPTION OF THE DRAWINGS

In order to more clearly illustrate the technical solutions in the embodiments of the present disclosure, the following briefly introduces the drawings needed in the description of the embodiments. The drawings in the following description are only some embodiments of the present disclosure, and those skilled in the art may also obtain other embodiments according to these drawings without creative efforts.

FIG. 1 is a structural schematic view of a wall-mounted bracket according to an embodiment of the present disclosure.

FIG. 2 is an exploded structural schematic view of a wall-mounted bracket according to an embodiment of the present disclosure.

FIG. 3 is an exploded structural schematic view of a wall-mounted bracket according to another embodiment of the present disclosure.

FIG. 4 is a schematic view of the wall-mounted bracket when holding the gaming device according to the embodiment as shown in FIG. 1.

FIG. 5 is a schematic view of the wall-mounted bracket when holding the gaming device according to the embodiment as shown in FIG. 3.

### DETAILED DESCRIPTION

The present disclosure will be clearly described below in conjunction with accompanying drawings and embodiments of the present disclosure. In particular, the following embodiments are only used to illustrate the present disclosure, but do not limit the scope of the present disclosure. The described embodiments are only some but not all of the embodiments of the present disclosure. All other embodiments obtained by those skilled in the art without making creative efforts belong to the scope of protection of the present disclosure.

The reference to “embodiments” in the present disclosure means that the specific features, structures, or characteristics of the wall-mounted bracket may be included in at least one embodiment of the present disclosure. The phrase appearing in different parts of the description does not necessarily refer to the same embodiment, nor is an independent or alternative embodiment mutually exclusive with other embodiments. Those skilled in the art understand explicitly and implicitly that the embodiments described herein may be combined with other embodiments.

It should be noted that, the expressions “first”, “second”, “third”, and the like are utilized for descriptive purposes only, and shall not be interpreted as indicating or implying relative importance or implicitly specifying the number of an indicated technical feature. Therefore, features defined by “first”, “second”, and “third” may explicitly or implicitly include at least one of such features. In the present disclosure, “multiple” means at least two, unless otherwise expressly specified.

In some embodiments, the present disclosure provides a wall-mounted bracket. The wall-mounted bracket includes a host holder and an accessory holder. The host holder is capable of being mounted on a bracket mounting wall; the host holder is configured to hold the host of a gaming device. The accessory holder is connected to a side of the host holder, and that side is away from the bracket mounting wall, and the accessory holder is configured to hold multiple accessories of the gaming device. The accessory holder comprises a first accessory holding portion and a second accessory holding portion, and the first accessory holding portion and the second accessory holding portion are arranged side by side.

In some embodiments, the accessory holder further includes a third accessory holding portion. The third accessory holding portion is arranged side by side with the first accessory holding portion and the second accessory holding portion; and the third accessory holding portion is located between the first accessory holding portion and the second accessory holding portion.

In some embodiments, the host holder includes a mounting plate, and the mounting plate is configured to be mounted on the bracket mounting wall.

In some embodiments, the mounting plate is arranged on a side the same as the placement side of the host of the gaming device.

In some embodiments, the host holder further includes a bottom plate and a side plate. The mounting plate, the bottom plate, and the side plate cooperatively define an accommodating space. The accommodating space is configured to hold the host of the gaming device and the accessory holder, and the accessory holder is detachably connected to the host holder.

In some embodiments, the bottom plate includes at least one through-hole, and the at least one through-hole is configured to reduce weight of the wall-mounted bracket.

In some embodiments, each of the first accessory holding portion and the second accessory holding portion is constructed as a base. The base and the mounting plate are arranged on the same side of the bottom plate, and the base is provided with a slot, and the accessories of the gaming device are capable of being placed in the slot.

In some embodiments, the host holder includes at least one first blocking plate, the at least one first blocking plate is arranged at a side of the bottom plate, and that side is opposite to the mounting plate. The at least one first blocking plate is configured to prevent the first accessory holder and the second accessory holder from falling off from the host holder.

In some embodiments, the host holder includes at least one second blocking plate, the at least one second blocking plate is arranged at a side of the bottom plate, and that side is adjacent to the mounting plate. The at least one second blocking plate is configured to prevent the first accessory holder and the second accessory holder from falling off from the host holder.

In some embodiments, the mounting plate is arranged on a side opposite to the placement side of the gaming device host.

In some embodiments, the host holder further includes a platform plate and a rib plate. A side of the rib plate is connected to the mounting plate, and an adjacent side to that side of the rib plate is connected to the platform plate in order to support the platform plate. The platform plate is configured to hold the host of the gaming device, and the accessory holder is detachably connected to a side of the platform plate, and that side is away from the bracket mounting wall.

In some embodiments, the host holder further includes a plug plate, and the plug plate is connected to a side of the platform plate, and that side is away from the bracket mounting wall. The plug plate is arranged parallel to the placement direction of the accessory holder. The accessory holder slides onto the plug plate, such that the accessory holder is detachably connected to the side of the platform plate.

In some embodiments, the platform plate includes at least one air vent, and the at least one air vent is configured to reduce the weight of the wall-mounted bracket.

In some embodiments, each of the first accessory holding portion and the second accessory holding portion is constructed as a supporting arm. The accessory holder includes a supporting body, and a side of the supporting body is connected to the platform plate, and an adjacent side of the side of the supporting body is connected to the supporting arm. The supporting arm is provided with a slot, and the accessory of the gaming device is capable of being held on the slot.

In some embodiments, each of the first accessory holding portion and the second accessory holding portion includes a charging component. The charging component is configured to charge the accessory of the gaming device, and the charging component includes an overcharge protector and a charging state indicator. The overcharge protector is capable of disconnecting the electrical connection between the accessory of the gaming device and the charging component. When the accessory of the gaming device has finished charging, the charging state indicator is configured to display the charging state of the accessory of the gaming device.

In some embodiments, the present disclosure provides a wall-mounted bracket. The wall-mounted bracket includes a host holder and an accessory holder. The host holder is capable of being mounted on a bracket mounting wall. The host holder is configured to hold a host of a gaming device. The accessory holder is connected to a side of the host holder, and that side is away from the bracket mounting wall, and the accessory holder is configured to hold multiple accessories of the gaming device. The host holder includes at least one through-hole, and the at least one through-hole is configured to reduce the weight of the wall-mounted bracket.

In some embodiments, the accessory holder includes a first accessory holding portion, a second accessory holding portion, and a third accessory holding portion. The first accessory holding portion, the second accessory holding portion, and the third accessory holding portion are arranged side by side, and the third accessory holding portion is located between the first accessory holding portion and the second accessory holding portion.

In some embodiments, the present disclosure provides a wall-mounted bracket. The wall-mounted bracket includes a host holder and an accessory holder. The host holder is capable of being mounted on a bracket mounting wall; the host holder is configured to hold a host of a gaming device. The accessory holder is connected to a side of the host holder, and that side is away from the bracket mounting wall, and the accessory holder is configured to hold multiple accessories of the gaming device.

In some embodiments, the accessory holder includes a first accessory holding portion and a second accessory holding portion, and the first accessory holding portion and the second accessory holding portion are arranged side by side. Each of the first accessory holding portion and the second accessory holding portion includes a charging component. The charging component is configured to charge the accessories of the gaming device.

In some embodiments, the host holder includes a mounting plate, and the mounting plate is configured to be mounted on the bracket mounting wall.

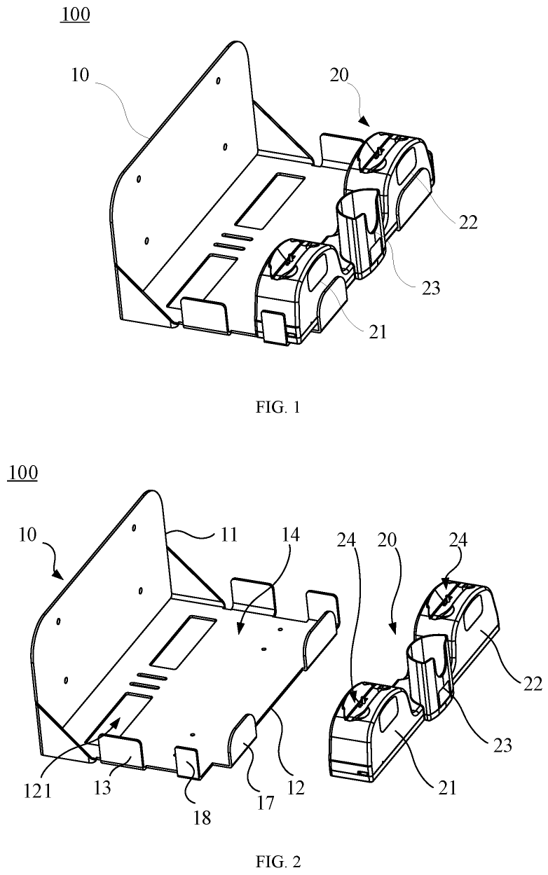

The present disclosure provides a wall-mounted bracket, as shown in FIG. 1 and FIG. 2. FIG. 1 is a structural schematic view of a wall-mounted bracket according to an embodiment of the present disclosure, and FIG. 2 is an exploded structural schematic view of a wall-mounted bracket according to an embodiment of the present disclosure. The wall-mounted bracket 100 may include a host holder 10 and an accessory holder 20. The host holder 10 may be configured to be hung on a bracket mounting wall, the host holder 10 is configured to hold the gaming device host. The accessory holder 20 is connected to a side of the host holder 10, and that side is away from the bracket mounting wall. The accessory holder 20 is configured to hold multiple accessories of the gaming device. The accessories of the gaming device may be a controller, a remote control, etc. of the gaming device.

The host holder 10 is arranged with a mounting plate 11. The mounting plate 11 may be hung on the bracket mounting wall. The bracket mounting wall may be one surface of a wall, furniture, etc. The specific installation method requires an expansion screw to pass through a mounting hole provided on the mounting plate 11 and lock the host holder 10 on the bracket mounting wall.

The wall-mounted bracket 100 provided in the present disclosure may be configured to be hung on the bracket mounting wall, making full use of the idle vertical space on one side of the wall to store the gaming device, thereby reducing the occupation of the user's readily available space.

In an embodiment, the host holder 10 also includes a bottom plate 12 and a side plate 13, and the mounting plate 11 is arranged on the same side as the host of the game device. The mounting plate 11, the base plate 12, and the side plate 13 define an accommodating space 14. The accommodating space 14 may be used to place and store the host of the gaming device and the accessory holder 20. The accessory holder 20 is detachably connected to the host holder 10. The accessory holder 20 and the host holder 10 are arranged separately, such that the accessory holder 20 and the host holder 10 may be reassembled after the accessory holder 20 and the host holder 10 are manufactured separately, thereby simplifying the processing and production of the wall-mounted bracket 100.

The bottom plate 12 may be arranged with at least one through-hole 121, and the at least one through-hole is configured to reduce weight of the wall-mounted bracket. As shown in FIG. 2, in this embodiment, the bottom plate 12 is opened with two through-holes 121 such that the whole weight of the wall-mounted bracket may be reduced, resulting in less materials needed and a lower production cost. Further, the bracket mounting wall needs to bear less force as a result of the less weight in whole, thus reducing the possibility that the wall-mounted bracket 100 might fall off from the bracket mounting wall. In other embodiments, the bottom plate 12 may be arranged with a plurality of through-holes 121, such as 3, 4, 5, 6 etc., which is not limited in the present disclosure.

The host holder 10 includes at least one first blocking plate 17, the at least one first blocking plate 17 is arranged at a side of the bottom plate 12, and that side is opposite to the mounting plate 11. The at least one first blocking plate 17 is configured to prevent the first accessory holder 21 and the second accessory holder 22 from falling off from the host holder 20. As shown in FIG. 2, the number of at least one first blocking plate 17 is two, with each extended from the side opposite to the mounting plate 11 of the bottom plate 12. One first blocking plate 17 stands against a side of the first accessory holder 21 and the other first blocking plate 17 stands against a side of the second accessory holder 22, such that the first accessory holder 21 and the second accessory holder 22 can be kept in a stable condition. In other embodiments, the side opposite to the mounting plate 11 of the bottom plate 12 may be connected with a plurality of first blocking plates 17, such as 3, 4, 5, 6 etc., which is not limited in the present disclosure.

The host holder 10 includes at least one second blocking plate 18, the at least one second blocking plate 18 is arranged at a side of the bottom plate 12, and that side is adjacent to the mounting plate 11. The at least one second blocking plate 18 is configured to prevent the first accessory holder 21 and the second accessory holder 22 from falling off from the host holder 10. As shown in FIG. 2, the number of at least one second blocking plate 18 is two, with each extended from the side adjacent to the mounting plate 11 of the bottom plate 12. One second blocking plate 18 stands against another side of the first accessory holder 21 and the other first blocking plate 18 stands against another side of the second accessory holder 22, such that the first accessory holder 21 and the second accessory holder 22 can be further kept in a more stable condition. In other embodiments, the side adjacent to the mounting plate 11 of the bottom plate 12 may be connected with a plurality of second blocking plates 18, such as 3, 4, 5, 6 etc., which is not limited in the present disclosure.

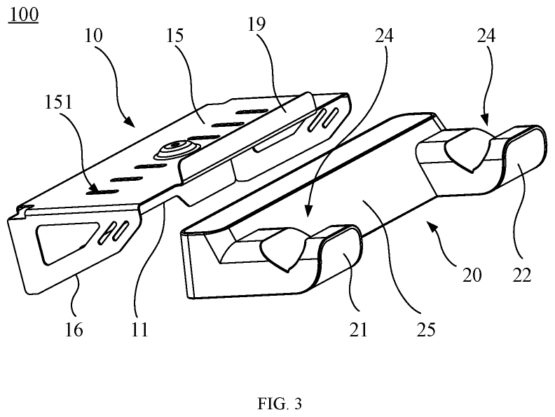

The mounting plate 11 may also be set on the side opposite to the placement direction of the host of the gaming device. FIG. 3 is an exploded structural schematic view of a wall-mounted bracket according to another embodiment of the present disclosure. In this embodiment, the host holder 10 also includes a platform plate 15 and a rib plate 16. A side of the rib plate 16 is connected to the mounting plate 11, and an adjacent side of that side of the rib plate 16 is connected to the platform plate 15. The platform plate 15 is configured to hold the host of the gaming device, and the accessory holder 20 is detachably connected to a side of the platform plate 15, and that side is away from the bracket mounting wall. Specifically, the accessory holder 20 and the platform plate 15 may be connected by bolts or clips, etc. In this way, the vertical storage space of the wall-mounted bracket 100 before assembly may be reduced, thus facilitating efficient packaging, storage, and transportation of the finished product of the wall-mounted bracket 100.

The host holder 10 may also include a plug plate 19, the plug plate 19 is connected to a side of the platform plate 15, and that side is away from the bracket mounting wall, and the plug plate 19 is arranged parallel to the placement direction of the accessory holder 20. The accessory holder 20 slides onto the plug plate 19, such that the accessory holder 20 is detachably connected to the side of the platform plate 15. As shown in FIG. 3, the plug plate 19 is formed in a rectangular shape which fits into the groove on the bottom of accessory holder 20. In this way, the host holder 10 and the accessory holder 20 can be separated such that they occupy a smaller place when they are packaged together. For example, when a batch of newly manufactured wall-mounted brackets 100 needs to be transported, the storage space needed would be smaller, thus reducing the packaging material and lowering the storage and transportation cost.

The platform plate 15 may also include at least one air vent 151, and the at least one air vent 151 is configured to reduce the weight of the wall-mounted bracket 100. As shown in FIG. 3, in this embodiment, the platform plate 15 is opened with multiple air vents 151 such that the whole weight of the wall-mounted bracket may be reduced, resulting in less materials needed and a lower production cost. Furthermore, the bracket mounting wall needs to bear less weight, thereby reducing the possibility that the wall-mounted bracket 100 might fall off from the bracket mounting wall.

The accessory holder 20 may include a first accessory holding portion 21 and a second accessory holding portion 22. The first accessory holding portion 21 and the second accessory holding portion 22 are arranged side by side. Each of the first accessory holding portion 21 and the second accessory holding portion 22 may be configured to place one controller of the gaming device.

Generally, the width of the host of the gaming device is roughly the same as the width of the two controllers of the gaming device when the two controllers of the gaming device are placed side by side. In the present disclosure, the first accessory holding portion 21 and the second accessory holding portion 22 are arranged on the outside of the host holder 10 side by side, and the outside is away from the bracket mounting wall. The space occupied by the wall-mounted bracket 100 in the front, rear and left and right directions of one side of the bracket mounting wall is reasonably distributed, and the width of the host holder 10 matches the width of the accessory holder 20 when both controllers 320 are placed on the accessory holder 20 side by side, thereby maximizing the efficiency of the space occupied by the gaming device.

As shown in FIG. 2, in an embodiment, the accessory holder 20 also includes a third accessory holding portion 23. The third accessory holding portion 23 is arranged side by side with the first accessory holding portion 21 and the second accessory holding portion 22. The third accessory holding portion 23 is located between the first accessory holding portion 21 and the second accessory holding portion 22, and the third accessory holding position 23 may be configured to place the remote control of the gaming device.

In an embodiment, each of the first accessory holding portion 21 and the second accessory holding portion 22 is constructed as a base. As shown in FIG. 2, the base and the mounting plate 11 are arranged on the same side of the bottom plate 12, and the base is provided with a slot 24. The gaming device accessory may be placed on the slot 24, stabilizing the placement of the accessory of the gaming device.

In another embodiment, each of the first accessory holding portion 21 and the second accessory holding portion 22 is constructed as a supporting arm. As shown in FIG. 3, the accessory holder 20 is provided with a supporting body 25, one side of the supporting body 25 is connected with the platform plate 15, and the adjacent side of that side of the supporting body 25 is connected with a support arm. The support arm is provided with a slot 24, and the accessory of the gaming device may be placed on the slot 24.

Further, each of the first accessory holding portion 21 and the second accessory holding portion 22 includes a charging component. The charging component is configured to charge the accessory of the gaming device. The charging component includes an overcharge protector and a charging state indicator. The overcharge protector may disconnect the electrical connection between the accessory of the game device and the charging component when the accessory of the game device has finished charging, preventing the accessory of the gaming device from overcharging and negatively affecting the battery life. The charging state indicator is used to display the charging state of the accessory of the gaming device, facilitating the users to check the charging progress of the accessory of the gaming device at any time. By setting the charging component in each of the first accessory holding portion 21 and the second accessory holding portion 22, the wall-mounted bracket 100 may be used to store the gaming device, and the gaming device may also be charged when not in use to improve the user experience.

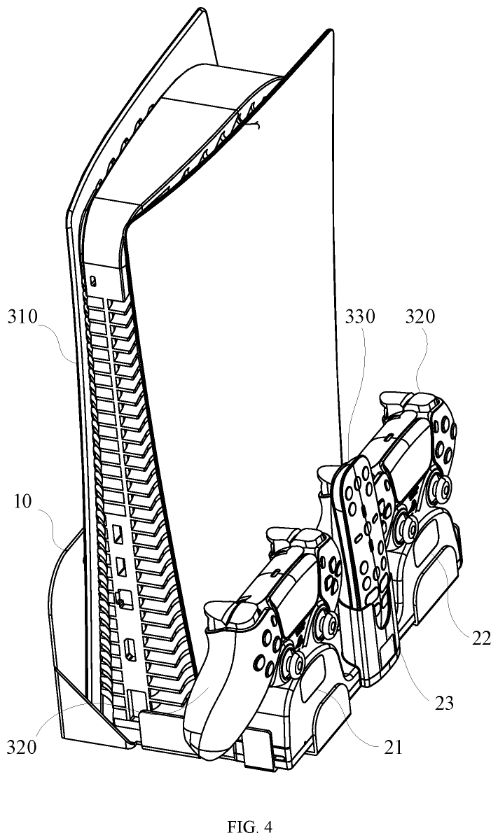

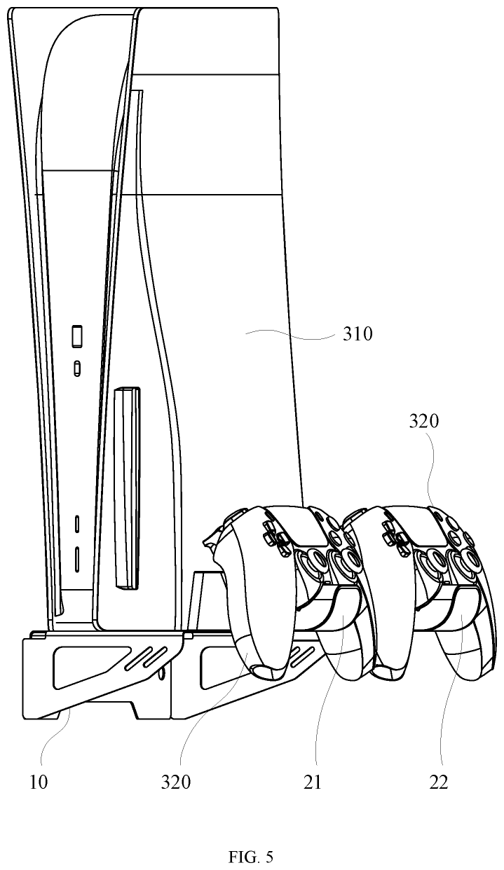

As shown in FIG. 4 and FIG. 5, FIG. 4 is a schematic view of the wall-mounted bracket when holding the gaming device according to the embodiment as shown in FIG. 1, and FIG. 5 is a schematic view of the wall-mounted bracket when holding the gaming device according to the embodiment as shown in FIG. 3. The gaming device includes a host 310, a controller 320 and a remote control 330. The host 310 is placed on the host holder 10, one controller 320 is placed in the first accessory holding portion 21, another controller 320 is placed in the second accessory holding portion 22, and the remote control 330 is placed in the third accessory holding portion 23. One controller 320, the remote control 330, and the other controller 320 are arranged side by side. The width of the host 310 of the gaming device matches the width of both controllers 320 when they are placed side by side, thereby maximizing the efficiency of the space occupied by the gaming device.

The wall-mounted bracket 100 provided in this disclosure has at least the following beneficial effects.

First, the wall-mounted bracket 100 may be hung on the bracket mounting wall, thereby optimizing idle vertical space to store the gaming device, thereby reducing the occupation of the user's readily available space.

Second, the first accessory holding portion 21 and the second accessory holding portion 22 are arranged side by side on the outside of the host holder 10, making full use of the space in the width direction of the host of the gaming device, thus the space occupied by the gaming device is minimized.

Third, each of the first accessory holding portion 21 and the second accessory holding portion 22 is equipped with a charging component, such that the wall-mounted bracket 100 may be used to store the accessories of the gaming device charged when the gaming device is not in use, thereby improving the user experience.

The above is only part of the embodiments of the present disclosure, and does not limit the scope of protection of the present disclosure. Any equivalent device or equivalent process transformation made by using the description of the present disclosure and the attached drawings, or directly or indirectly applied in other relevant technical fields, are equally included in the scope of protection of the present disclosure.

What is claimed is:

1. A wall-mounted bracket, comprising:
a host holder and an accessory holder;
wherein the host holder is capable of being mounted on a bracket mounting wall; the host holder is configured to hold the host of a gaming device, and the accessory holder is connected to a side of the host holder, and that side is away from the bracket mounting wall, and the accessory holder is configured to hold multiple accessories of the gaming device;
the accessory holder comprises a first accessory holding portion and a second accessory holding portion, and the first accessory holding portion and the second accessory holding portion are arranged side by side.

2. The wall-mounted bracket according to claim 1, wherein the accessory holder further comprises a third accessory holding portion; the third accessory holding portion is arranged side by side with the first accessory holding portion and the second accessory holding portion; and the third accessory holding portion is located between the first accessory holding portion and the second accessory holding portion.

3. The wall-mounted bracket according to claim 1, wherein the host holder comprises a mounting plate, and the mounting plate is configured to be mounted on the bracket mounting wall.

4. The wall-mounted bracket according to claim 3, wherein the mounting plate is arranged on a side the same as the placement side of the host of the gaming device.

5. The wall-mounted bracket according to claim 4, wherein the host holder further comprises a bottom plate and a side plate; the mounting plate, the bottom plate, and the side plate cooperatively define an accommodating space; the accommodating space is configured to hold the host of the gaming device and the accessory holder, and the accessory holder is detachably connected to the host holder.

6. The wall-mounted bracket according to claim 5, wherein the bottom plate comprises at least one through-hole, and the at least one through-hole is configured to reduce weight of the wall-mounted bracket.

7. The wall-mounted bracket according to claim 5, wherein each of the first accessory holding portion and the second accessory holding portion is constructed as a base, the base and the mounting plate are arranged on a same side of the bottom plate, the base is provided with a slot, and the accessory of the gaming device is capable of being placed in the slot.

8. The wall-mounted bracket according to claim 5, wherein the host holder comprises at least one first blocking plate, the at least one first blocking plate is arranged at a side of the bottom plate and the side is opposite to the mounting plate; and the at least one first blocking plate is configured to prevent the first accessory holder and the second accessory holder from falling off from the host holder.

9. The wall-mounted bracket according to claim 5, wherein the host holder comprises at least one second blocking plate, the at least one second blocking plate is arranged at a side of the bottom plate and the side is adjacent to the mounting plate; and the at least one second blocking plate is configured to prevent the first accessory holder and the second accessory holder from falling off from the host holder.

10. The wall-mounted bracket according to claim 3, wherein the mounting plate is arranged on a side opposite to the placement side of the gaming device host.

11. The wall-mounted bracket according to claim 10, wherein the host holder further comprises a platform plate and a rib plate, a side of the rib plate is connected to the mounting plate, and an adjacent side to the side of the rib plate is connected to the platform plate in order to support the platform plate; the platform plate is configured to hold the host of the gaming device, and the accessory holder is detachably connected to a side of the platform plate, and that side is away from the bracket mounting wall.

12. The wall-mounted bracket according to claim 11, wherein the host holder further comprises a plug plate, the plug plate is connected to a side of the platform plate, and that side is away from the bracket mounting wall, and the plug plate is arranged parallel to the placement direction of the accessory holder; the accessory holder slides onto the plug plate, such that the accessory holder is detachably connected to the side of the platform plate.

13. The wall-mounted bracket according to claim 12, wherein the platform plate comprises at least one air vent, and the at least one air vent is configured to reduce the weight of the wall-mounted bracket.

14. The wall-mounted bracket according to claim 11, wherein each of the first accessory holding portion and the second accessory holding portion is constructed as a supporting arm, the accessory holder comprises a supporting body, and a side of the supporting body is connected to the platform plate, and an adjacent side of the side of the supporting body is connected to the supporting arm, and the supporting arm is provided with a slot, and the accessory of the gaming device is capable of being inserted into the slot.

15. The wall-mounted bracket according to claim 1, wherein each of the first accessory holding portion and the second accessory holding portion comprises a charging component; the charging component is configured to charge the accessory of the gaming device, and the charging component comprises an overcharge protector and a charging state indicator; the overcharge protector is capable of disconnecting the electrical connection between the accessory of the gaming device and the charging component when the accessory of the gaming device has finished charging, and the charging state indicator is configured to display the charging state of the accessory of the gaming device.

16. A wall-mounted bracket, comprising:
a host holder and an accessory holder;
wherein the host holder is capable of being mounted on a bracket mounting wall; the host holder is configured to hold a host of a gaming device, the accessory holder is connected to a side of the host holder, and that side is away from the bracket mounting wall, and the accessory holder is configured to hold an accessory of the gaming device;
the host holder comprises at least one through-hole, and the at least one through-hole is configured to reduce the weight of the wall-mounted bracket.

17. The wall-mounted bracket according to claim 16, the accessory holder comprises a first accessory holding portion, a second accessory holding portion, and a third accessory holding portion;
wherein the first accessory holding portion, the second accessory holding portion, and the third accessory holding portion are arranged side by side, and the third accessory holding portion is located between the first accessory holding portion and the second accessory holding portion.

18. A wall-mounted bracket, comprising:
a host holder and an accessory holder;
wherein the host holder is capable of being mounted on a bracket mounting wall; the host holder is configured to hold a host of a gaming device, the accessory holder is connected to a side of the host holder, and that side is away from the bracket mounting wall, and the accessory holder is configured to hold an accessory of the gaming device.

19. The wall-mounted bracket according to claim 18, the accessory holder comprises a first accessory holding portion and a second accessory holding portion, and the first accessory holding portion and the second accessory holding portion are arranged side by side;
wherein each of the first accessory holding portion and the second accessory holding portion comprises a charging component; the charging component is configured to charge the accessory of the gaming device.

20. The wall-mounted bracket according to claim 18,
wherein the host holder comprises a mounting plate, and the mounting plate is configured to be mounted on the bracket mounting wall.
